(19) United States
(12) Patent Application Publication
(10) Pub. No.: US 2020/0301974 A1
(43) Pub. Date: Sep. 24, 2020

(54) SEARCH SUGGESTIONS WITHIN A CLIENT INSTANCE

(71) Applicant: ServiceNow, Inc., Santa Clara, CA (US)

(72) Inventors: Eugene Aaron Shtilkind, San Diego, CA (US); Rohit Katta, San Diego, CA (US); Kai Guo, San Diego, CA (US); Andrii Kovalenko, San Diego, CA (US); Jeffrey Michael Cooper, El Cajon, CA (US); Wei Rui, San Diego, CA (US); Dwayne Lavon Love, San Diego, CA (US)

(21) Appl. No.: 16/358,056

(22) Filed: Mar. 19, 2019

(51) Int. Cl. G06F 16/9032; G06F 16/2457; G06F 16/9535

(52) U.S. Cl. CPC G06F 16/90324; G06F 16/9535; G06F 16/24578

(57) ABSTRACT

A client instance provides search suggestions based on a partial search query. The search suggestions include user search suggestions based on previous search queries performed by the user and instance search suggestions based on previous search queries performed on the instance. The client instance filters the instance search suggestions based on filter criteria associated with the user, such as an interface used by the user, a search context, user group that the user belongs to, domain used by the user, and so on. The client instance may remove the search suggestions that include blacklisted terms. The client instance may rank the search suggestions (e.g., based on frequency and/or recency) and enable the user to select those ranked search suggestions that meet or exceed a threshold.

### BACKGROUND

The present disclosure relates generally to providing search suggestions within a network environment cloud infrastructure client instance (also referred to herein as a client instance or instance).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

A cloud-based information technology platform may include a virtual server that enables aspects of a client instance. One or more software applications running in the client instance may enable a user to search for information by, for example, entering a search query into a search field provided in the application and returning search results based on the search query. However, it may be tedious or inefficient, particularly in cases where the user is accessing the client instance via a mobile device, for the user to enter a full or complete search query.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

As presently disclosed, a cloud-based information technology platform may include a virtual server that enables a network environment cloud infrastructure client instance (also referred to herein as a client instance or instance). A software application (e.g., a browser application, a productivity suite application, a map application, a mobile application, and so forth) running in the client instance may enable a user to search for information by, for example, entering a search query into a search field and returning search results based on the search query. To create a more user-friendly experience, particularly in the case where the user is accessing the client instance via a mobile device, the application may suggest search queries (also referred to herein as search suggestions) as the user is entering the search query. That is, the application may suggest the search suggestions based on a partial search query.

The search suggestions may include user search suggestions that are based on previous search queries performed by the user and instance search suggestions that are based on previous search queries performed on the instance. In some embodiments, the application may filter the instance search suggestions based on filter criteria associated with the user or a device being employed by the user, such as an interface (e.g., mobile or web portal) used by the user, a search context (e.g., associated with a software application or page at which the search query is entered), user group that the user belongs to, domain used by the user, and so on. The application may remove or downweight search suggestions that include blacklisted terms. The application running on the client instance may rank the search suggestions (e.g., based on frequency and/or recency) and enable the user to select those ranked search suggestions that meet or exceed a threshold. In this manner, the application may provide relevant search suggestions to the user without the user having to enter a full search query, saving time and providing a better user experience.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a flowchart of a process for providing search suggestions within a client instance of FIG. 2, according to embodiments of the present disclosure

FIG. 5 is a view of a web portal providing search suggestions within the client instance of FIG. 2, according to embodiments of the present disclosure;

FIG. 6 is a view of a web portal listing previously performed search queries on the client instance of FIG. 2 in a table, according to embodiments of the present disclosure;

FIG. 7 is a view of a web portal listing search suggestions in a table that were generated based on search queries previously performed on the client instance of FIG. 2, according to embodiments of the present disclosure;

FIG. 8 is a view of a web portal listing blacklisted terms in a table, according to embodiments of the present disclosure;

FIG. 9 is a view of a mobile interface providing search suggestions within a client instance of FIG. 2, according to embodiments of the present disclosure; and

FIG. 10 is a view of a web portal providing search suggestions within a client instance of FIG. 2 for a user that does not have a role as system administrator, according to embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As presently disclosed, a cloud-based information technology platform may include a virtual server that enables a network environment and supports aspects of a service provider cloud infrastructure client instance (also referred to herein as a client instance or instance). A software application running in the client instance may enable a user to search for information by, for example, entering a search query into a search field and returning search results based on the search query. To create a more user-friendly experience, particularly in the case where the user is accessing the client instance via a mobile device, the application may suggest search queries (also referred to herein as search suggestions) as the user is entering the search query. That is, the application may suggest the search suggestions based on a partial search query.

The search suggestions may include user-based search suggestions that are based on previous search queries performed by the user and instance-based search suggestions that are based on previous search queries performed on the instance (e.g., within a organization or organizational unit associated with that instance). In some embodiments, the application may filter the search suggestions based on filter criteria associated with the user, such as an interface (e.g., mobile or web portal) used by the user, a search context (e.g., associated with a software application or page at which the search query is entered), a user group that the user belongs to, a domain used by the user, and so on. The application may remove or downweight (e.g., lower the rank of) the search suggestions that include blacklisted terms. The application may rank the search suggestions (e.g., based on frequency and/or recency) and enable the user to select those ranked search suggestions that meet or exceed a threshold. In this manner, the application may provide relevant search suggestions to the user without the user having to enter a full search query, saving time and providing a better user experience.

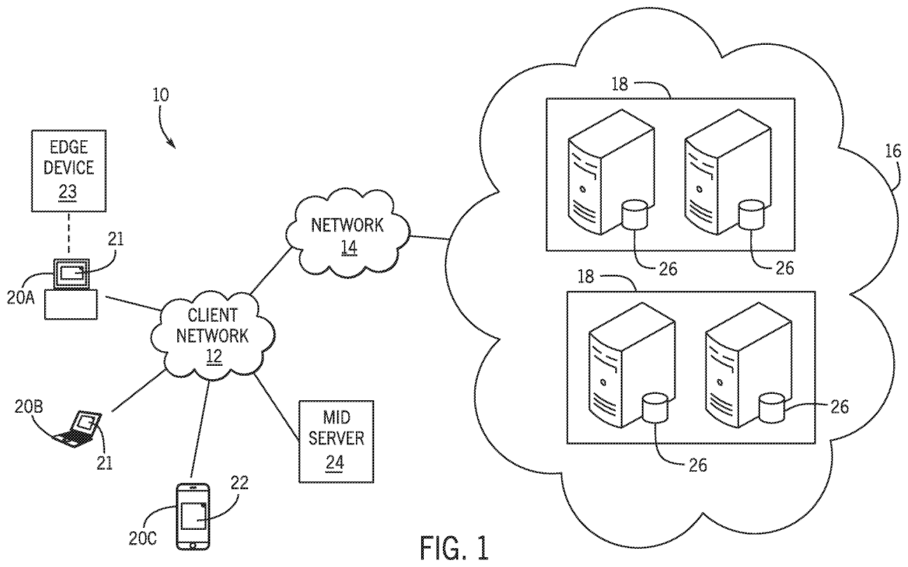

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20, such as a desktop computer 20A, a laptop computer 20B, and a mobile device 20C (e.g., a smartphone), so that the client devices 20 are able to communicate with each other and/or with the network hosting the platform 16. The client devices 20 may be computing systems and/or other types of computing devices generally referred to as Internet of Things (IoT) devices that access cloud computing services, for example, via a web browser application or portal 21, a mobile interface 22, or via an edge device 23 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

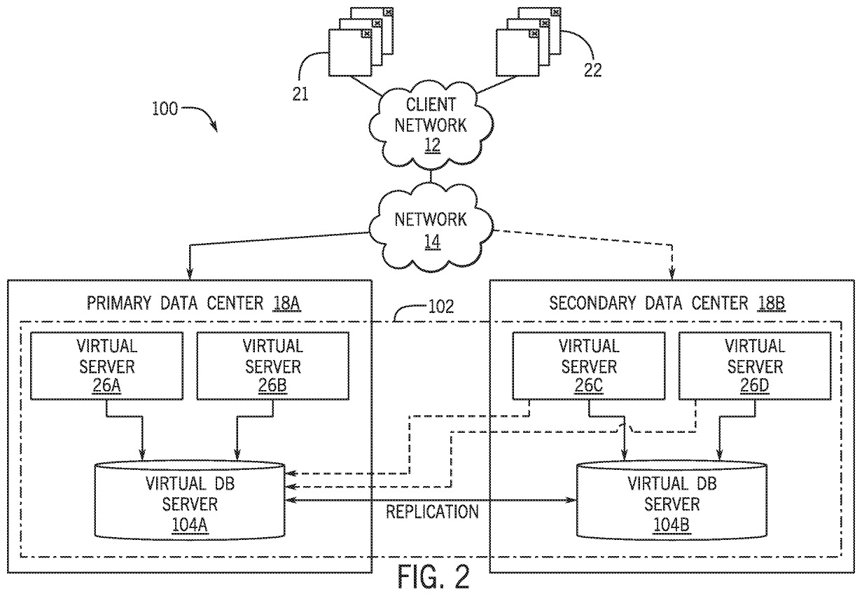

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2). The client instance 102 may enable any suitable number of web portals 21, mobile interfaces 22, and/or any other suitable user interfaces that facilitate providing cloud computing services to client devices 20.

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

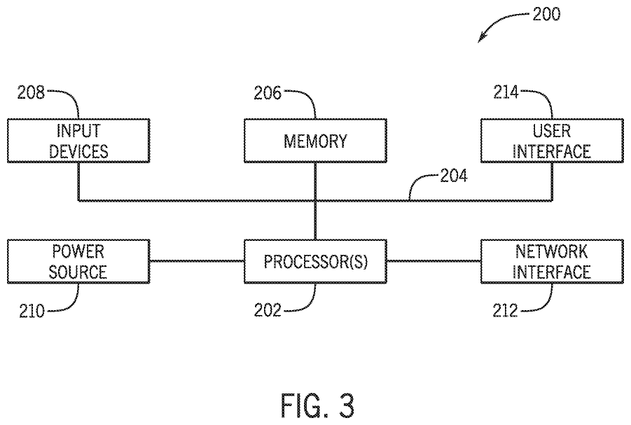

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing system 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

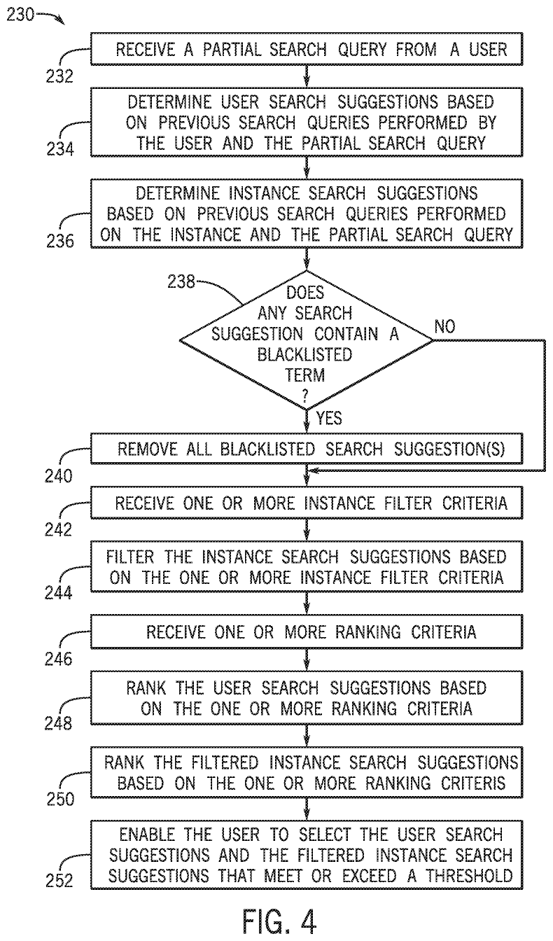

With the preceding background discussion in mind, FIG. 4 is a flowchart of a process 230 for providing search suggestions within a client instance 102 of FIG. 2, according to embodiments of the present disclosure. The process 230 may be implemented in the form of a software application that includes instructions executable by at least one suitable processor present in a device employed on the cloud computing system 10. In particular, the process 230 may be performed on a device in communication with the client instance 102, such as by a web browser application or portal 21 or mobile interface 22. The illustrated process 230 is merely provided as an example, and in other embodiments, certain illustrated steps of the process 230 may be performed in other orders, skipped, or repeated, in accordance with the present disclosure.

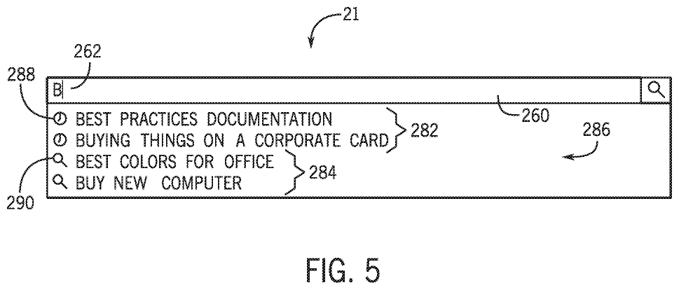

As illustrated in process block 232, a processor 202 receives a partial search query from a user, such as via a dynamic process by which a growing character string is provided as the partial search query input as a user enters a search. For example, FIG. 5 is a perspective view of a web portal 21 providing search suggestions within a client instance 102 of FIG. 2, according to embodiments of the present disclosure. The web portal 21 includes a search field 260 in the form of a text box. A user has entered a partial search query 262 (e.g., “b”). The user may enter the partial search query 262 in the process of entering a full search query (e.g., “best practices documentation”). The web portal 21 may send the partial search query 262 to the processor 202, and may send subsequent partial search queries 262 (e.g., “be”, “bes”, and so on) to the processor 202 as the user continues entering the search query.

Turning back to FIG. 4, in process block 234, the processor 202 determines user-based search suggestions based on previous search queries performed by the user and the partial search query 262. In particular, a memory or data store (e.g., database) in communication with the processor 202 may store previous search queries performed by the user (e.g., in the memory 206 or a database in communication with with the application). As such, the processor 202 may determine the previous search queries performed by the user that include the partial search query 262. For example, the user may have performed the previous search query “best practices documentation”, and, accordingly, the processor 202 may determine that this previous search query is a user search suggestion because it includes the partial search query 262 “b”.

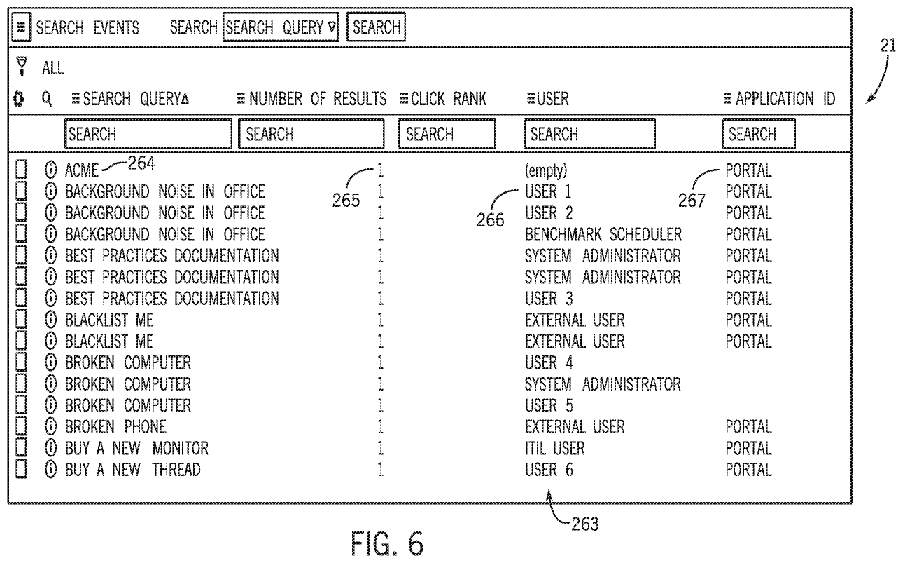

In process block 236, the processor 202 also determines instance-based search suggestions based on previous search queries performed on the client instance 102 (which may be associated with a respective organization or enterprise or a department or other sub-unit within such an organization) and the partial search query 262. In particular, the previous search queries performed on the instance 102 may include search queries performed by other users on the instance 102. The processor 202 may store previous search queries performed by users on the instance 102 (e.g., in the memory 206 or a database in communication with the application on which the search is being performed). For example, FIG. 6 is a perspective view of a web portal 21 listing previously performed search queries (e.g., search events) on the client instance 102 of FIG. 2 in a table, according to embodiments of the present disclosure. As illustrated, the table 263 includes the previously performed search queries 264, the number of results 265 returned from the search query 264, the user 266 performing the search query 264, and search context information 267 associated with the search query 264 (e.g., identification of the software application at which the search query 264 was entered). It should be understood, any suitable metric or information may be stored in the table 263 associated with each previously performed search query 264.

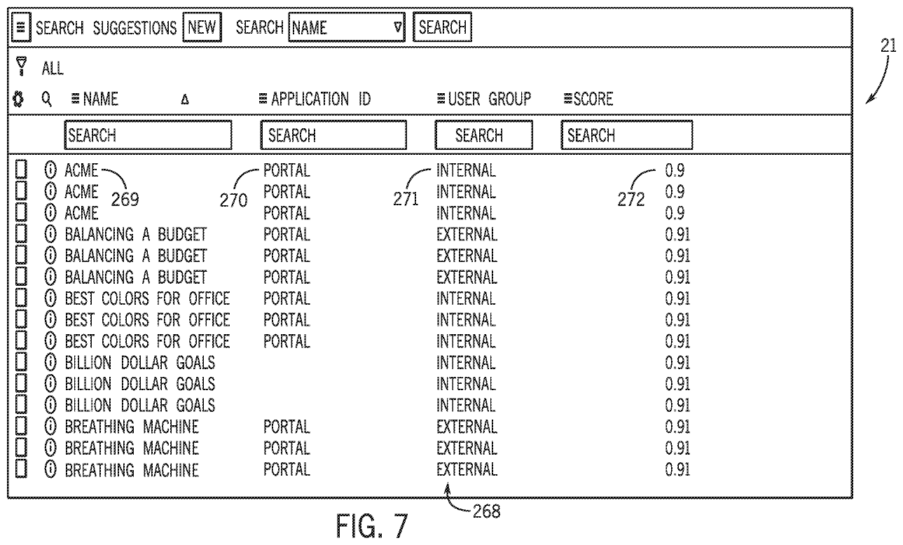

In some embodiments, the processor 202 may generate search suggestions (including the user-based search suggestions and the instance-based search suggestions) based on, for example, the table 263 of previously performed search queries in FIG. 6. For example, FIG. 7 is a perspective view of a web portal 21 listing search suggestions in a table that were generated based on search queries previously performed on the client instance 102 of FIG. 2, according to embodiments of the present disclosure. As illustrated, the table 268 includes the search suggestion 269, search context information 270 associated with the search suggestion 269 (e.g., identification of the software application at which the search suggestion 269 was entered), a user group 271 that performed the search suggestion 269, and score 272 of the search suggestion 269. The score 272 may be any suitable metric used to indicate a relevancy of the search suggestion 269. For example, the processor 202 may generate the score 272 of a search suggestion 269 based on frequency of the search suggestion 269 being performed, recency or how recently the search suggestion 269 was last performed, frequency of the search suggestion 269 being performed in a recent period of time (e.g., to determine how the search suggestion 269 trending), and so on. Any suitable period of time may be used to determine whether the search suggestion 269 is trending, such as determining the number of times the search suggestion 269 was performed in the last day, week, month, six months, year, five years, and so on. It should be understood, any suitable metric or information may be stored in the table 268 associated with each search suggestion 269.

In some cases, the processor 202 may generate the search suggestions 269 in the table 268 of FIG. 7, and determine the user search suggestions (in process block 234) by filtering the table 268 based on the user.

As such, the processor 202 may determine the previous search queries performed on the client instance 102 that include the partial search query 262. For example, the previous search queries performed on the client instance 102 may include the search query “best colors for office”, and, accordingly, the processor 202 may determine that this previous search query is an instance search suggestion because it includes the partial search query 262 “b”.

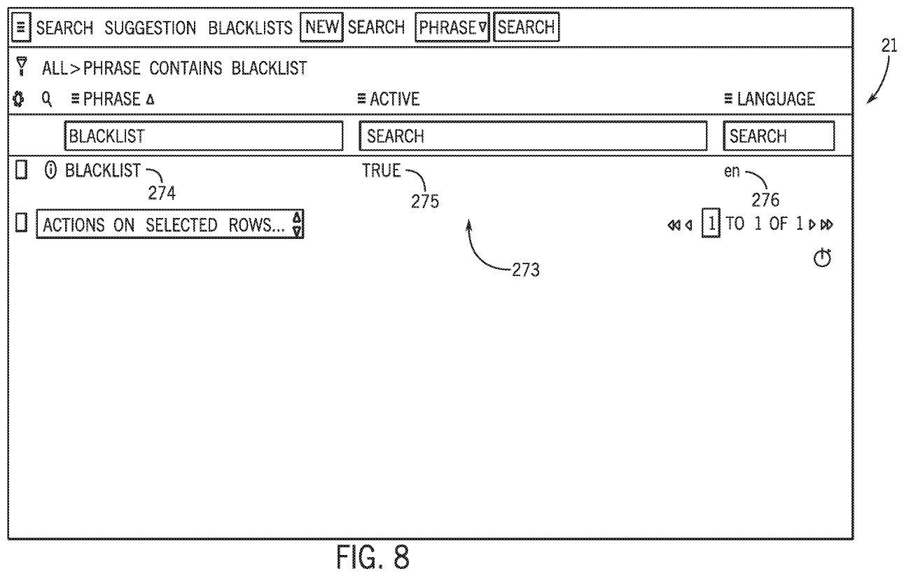

In some embodiments, the processor 202 may ensure that the search suggestions do not include those that have blacklisted terms. That is, certain terms may be prohibited due to a variety of reasons, such as suitability, security, confidentiality and so on. The processor 202 may store the blacklisted terms (e.g., in the memory 206 or other suitable data store). In some cases, the blacklisted terms may include blacklisted formats that are associated with terms that may be prohibited. For example, a blacklisted format may include three numbers, followed by a hyphen, followed by two numbers, followed by a hyphen, followed by four numbers (e.g., “XXX-XX-XXXX”) because this format is associated with social security numbers which may be prohibited for security and/or confidentiality reasons. FIG. 8 is a perspective view of a web portal 21 listing blacklisted terms in a table, according to embodiments of the present disclosure. The table 273 includes the blacklisted term “blacklist” 274, as well as details of the blacklisted term. For example, the blacklisted term “blacklist” 274 is active (as indicated by the “true” value 275) and is part of the English language (as indicated by the “en” value 276).

As such, and turning back to FIG. 4, in decision block 238, the processor 202 determines whether any of the search suggestions contain a blacklisted term (e.g., 274). If so, the processor 202 removes the blacklisted search suggestion(s), such that the blacklisted search suggestions may not be provided, displayed, or otherwise enabled to be viewed and/or selected by the user.

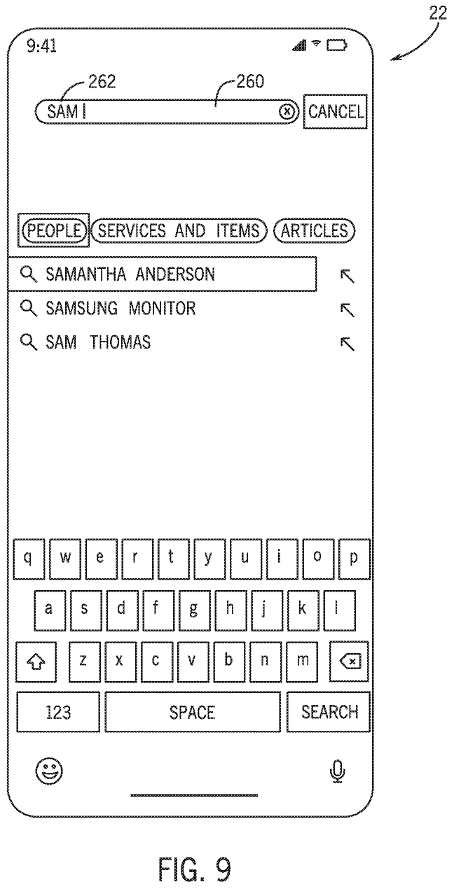

In process block 242, the processor 202 receives one or more instance filter criteria. The instance filter criteria may include any suitable criteria used to filter the instance search suggestions to generate more relevant search suggestions for the user. For example, the instance filter criteria may be associated with the interface (e.g., mobile or web portal) used by the user. As illustrated in FIG. 5, the interface used by the user is a web portal 21. As such, the instance filter criteria may include search queries that were performed on a web portal 21 interface. In some cases, the interface may be, for example, a mobile interface 22. For example, FIG. 9 is a perspective view of a mobile interface 22 providing search suggestions within a client instance 102 of FIG. 2, according to embodiments of the present disclosure. In such a case, the instance filter criteria may include search queries that were performed on a mobile interface 22. In this manner, the processor 202 may filter the instance search suggestions using the instance filter criteria to generate search suggestions relevant to the user's interface.

In additional or alternative embodiments, the instance filter criteria may be associated with a search context (e.g., associated with a software application or page at which the search query is entered). For example, the web portal 21 of FIG. 5 may be able to provide, enable access to, or execute multiple software applications, including a knowledge base application. In such an example, the search field 260 of the web portal 21 of FIG. 5 may be displayed or provided as part of the knowledge base application. As such, the instance filter criteria may include search queries that were performed and/or entered search fields 260 that were provided or displayed as part of the knowledge base application. As another example, the mobile interface 22 of FIG. 9 may be able to provide, enable access to, or execute multiple software applications, including a catalog application. In such an example, the search field 260 of the mobile interface 22 of FIG. 9 may be displayed or provided as part of the catalog application. As such, the instance filter criteria may include search queries that were performed and/or entered search fields 260 that were provided or displayed as part of the catalog application. In this manner, the processor 202 may filter the instance search suggestions using the instance filter criteria to generate search suggestions relevant to the user's search context.

The instance filter criteria may also or alternatively be associated with a user group (e.g., a company, organization, department, regional office, location, user role, and so on) that the user belongs to. For example, the user may be an employee at a certain company. As such, the instance filter criteria may include search queries that were performed by other users of the same company. As another example, the user may have a role (e.g., as defined by the client instance 102) as a system administrator. As such, the instance filter criteria may include search queries that were performed by other users having the role of system administrator. In this manner, the processor 202 may filter the instance search suggestions using the instance filter criteria to generate search suggestions relevant to the user's role.

In some cases, the client instance 102 may include multiple domains, such that the client instance 102 may provide different services on each domain. As such, the client instance 102 may provide a first service to users of a first domain, and a second service to users of a first domain. In such multi-domain instances, data of one domain may not be accessible to users of another domain, and vice versa. In such cases, the instance filter criteria may be associated with the domain at which the search query was performed. For example, in FIG. 5, the user may be performing a search query in the web portal 21 of a first domain of a client instance 102, which includes multiple domains. That is, the partial search query 262 received in process block 232 was entered in the first domain. As such, the instance filter criteria may include search queries that were performed in the first domain of the instance 102. In this manner, the processor 202 may filter the instance search suggestions using the instance filter criteria to generate search suggestions relevant to the user's domain.

Turning back to FIG. 4, in process block 244, the processor 202 filters the instance search suggestions based on the one or more instance filter criteria. That is, the processor 202 may remove any instance search suggestions that do not meet the instance filter criteria. For example, if the instance filter criteria includes search queries that were performed on a web portal 21, then the processor 202 may remove any instance search suggestions that were not performed on the web portal 21.

In process block 246, the processor 202 receives one or more ranking criteria. The ranking criteria may be any suitable criteria used to rank the search suggestions, such as frequency of the search queries being performed, recency or how recently the search queries were last performed, frequency of the search queries being performed in a recent period of time (e.g., to determine what search queries are currently trending), and so on. Any suitable period of time may be used to determine what search queries are currently trending, such as determining the search queries performed in the last day, week, month, six months, year, five years, and so on. In some embodiments, the ranking criteria may include the instance filter criteria received in process block 242.

In process block 248, the processor 202 ranks the user search suggestions based on the one or more ranking criteria. For example, if the ranking criteria includes the frequency of the search queries being performed, then the processor 202 ranks the user search suggestions based on the frequency of each search suggestion being performed.

In process block 250, the processor 202 ranks the instance search suggestions based on the one or more ranking criteria. For example, if the ranking criteria includes the frequency of the search queries being performed in a recent period of time (e.g., in a recent period of time), then the processor 202 ranks the instance search suggestions based on the frequency of each search suggestion being performed in the recent period of time. While the processor 202 is described as ranking the user search suggestions and the instance search suggestions using the same ranking criteria, it should be understood that different ranking criteria may be used to rank the user search suggestions when compared to ranking the instance search suggestions. For example, in some embodiments, the ranking criteria may include the instance filter criteria received in process block 242. As such, the processor 202 may rank the instance search suggestions based on, for example, whether the instance search suggestions have the same search context as the partial search query 262 received in process block 242. As illustrated in FIG. 7, the processor 202 may generate a score 272 of each search suggestion 269 based on, for example, the ranking criteria. The processor 202 may then sort the search suggestions 269 by the score 272 to rank the search suggestions 269.

In process block 252, the processor 202 enables the user to select the user-based search suggestions and the instance search suggestions that meet or exceed a threshold. In particular, the processor 202 may determine those user search suggestions that meet or exceed a threshold and those instance-based search suggestions that meet or exceed a threshold. The thresholds may include any suitable threshold used to display or provide a reasonable number of search suggestions to the user. The threshold used to evaluate the user search suggestions may be the same or different than the threshold used to evaluate the instance search suggestions. For example, the threshold may include the top two ranked user search suggestions and the top two ranked instance search suggestions. As such, the processor 202 may enable the user to select the top two ranked user search suggestions and the top two ranked instance search suggestions. As another example, the threshold may include the top two ranked user search suggestions and the top one percent of ranked instance search suggestions. As such, the processor 202 may enable the user to select the top two ranked user search suggestions and the top one percent of ranked instance search suggestions.

The processor 202 may enable the user to select the user search suggestions and the instance search suggestions by displaying or providing the search suggestions in a drop down list or menu and performing a search using the search suggestion when the search suggestion is selected by the user. For example, in FIG. 5, the processor 202 enables the user to select the user search suggestions and the instance search suggestions that meet or exceed a threshold by displaying the user search suggestions 282 and the instance search suggestions 284 in the drop down menu 286. In some embodiments, the processor 202 may indicate which search suggestions are user search suggestions 282 and which search suggestions are instance search suggestions 284. As illustrated, the processor 202 provides an indication 288 (e.g., a visual indication) of the user search suggestions 282 in the form of a graphical clock, and an indication 290 (e.g., a visual indication) of the instance search suggestions 284 in the form of a graphical magnifying glass. Advantageously, the process 230 enables a first time user of the web portal 21 and/or the mobile interface 22 to receive search suggestions (e.g., via the instance search suggestions) even if the user has not performed a previous search query. In this manner, the process 230 may provide relevant search suggestions 282, 284 to the user without the user having to enter a full search query, saving time and providing a better user experience.

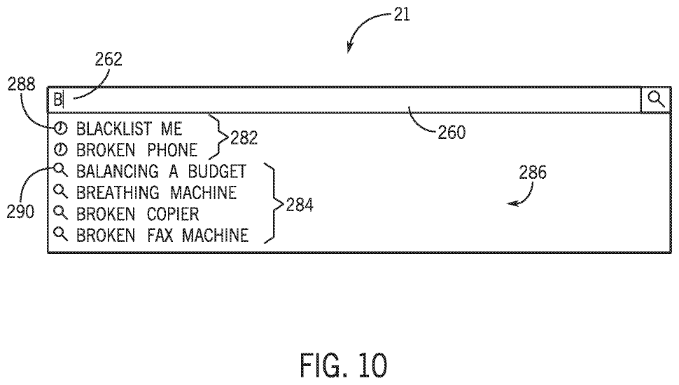

The example search suggestions shown in FIG. 5 may be for a user who has a role of a system administrator. As such, the search suggestions 282, 284 displayed in the drop down menu 286 may include user search suggestions 282 that were previous search queries performed by the user and instance search suggestions 284 that previous search queries performed on the instance 102 by other users that had roles as system administrators. As another example, FIG. 10 is a perspective view of a web portal 21 providing search suggestions within a client instance 102 of FIG. 2 for a user that does not have a role as system administrator, according to embodiments of the present disclosure. As such, the instance filter criteria used to generate the instance search suggestions 284 may include search queries that were performed by other users having the same role as the user, or the instance filter criteria may not include a user role.

In some embodiments, the client interface 102 may include the capability of disabling having search queries contribute to search suggestions. For example, a system administrator may search for a legacy component, but may desire that the search query not contribute to future search suggestions to avoid having other users attempt to install or purchase the legacy component. As such, the system administrator may disable having his search query contribute to search suggestions.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . .” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A cloud computing system comprising:
one or more data centers;
a client instance hosted by the one or more data centers, wherein the client instance is accessible by one or more remote client networks; and
a user interface enabled by the client instance that facilitates providing a cloud computing service to a client device, wherein the client instance is configured to:
receive a partial search query from a user via the user interface;
determine user-based search suggestions based on previous search queries performed by the user and the partial search query;
determine instance-based search suggestions based on previous search queries performed on the client instance and the partial search query;
filter the instance search suggestions based on one or more instance filter criteria;
rank the user-based search suggestions and the instance-based search suggestions based on one or more ranking criteria; and
enable selection of the user-based search suggestions and the instance-based search suggestions that meet or exceed a threshold.

2. The cloud computing system of claim 1, wherein the client device comprises a desktop computer or a laptop computer, wherein the user interface comprises a web portal, wherein the one or more instance filter criteria comprises search queries performed on the web portal.

3. The cloud computing system of claim 2, wherein the client instance is configured to enable a mobile interface that facilitates providing the cloud computing service to a mobile device.

4. The cloud computing system of claim 1, wherein the client device comprises a mobile device, wherein the user interface comprises a mobile interface, wherein the one or more instance filter criteria comprises search queries performed on the mobile interface.

5. The cloud computing system of claim 4, wherein the client instance is configured to enable a web portal that facilitates providing the cloud computing service to a desktop computer or a laptop computer.

6. The cloud computing system of claim 1, wherein the user interface is configured to execute a plurality of software applications, wherein the partial search query is entered via a software application of the plurality of software applications, wherein the one or more instance filter criteria comprises search queries entered via the software application of the plurality of software applications.

7. The cloud computing system of claim 1, wherein the client instance is configured to provide a plurality of user groups, wherein a user group of the plurality of user groups comprises the user, wherein the one or more instance filter criteria comprises search queries performed by users of the user group of the plurality of user groups.

8. The cloud computing system of claim 7, wherein the user group comprises a company, organization, department, regional office, location, or user role.

9. The cloud computing system of claim 1, wherein the client instance comprises a plurality of domains, wherein the user interface is enabled in a domain of the plurality of domains, wherein the one or more instance filter criteria comprises search queries performed in the domain of the plurality of domains.

10. A tangible, non-transitory, machine-readable-medium, comprising machine-readable instructions that, when executed by a processor, cause the processor to perform acts comprising:
receiving a partial search query via a client instance of a cloud computing system;
determining instance search suggestions based on previous search queries performed on the client instance and the partial search query;
filtering the instance search suggestions based on one or more instance filter criteria;
ranking the instance search suggestions based on one or more ranking criteria; and
enabling selection of the instance search suggestions that meet or exceed a threshold.

11. The tangible, non-transitory, machine-readable-medium of claim 10, wherein the one or more ranking criteria comprises frequency of the instance search suggestions being performed.

12. The tangible, non-transitory, machine-readable-medium of claim 10, wherein the one or more ranking criteria comprises recency of the instance search suggestions being last performed.

13. The tangible, non-transitory, machine-readable-medium of claim 10, wherein the one or more ranking criteria comprises frequency of the instance search suggestions being performed in a recent period of time.

14. The tangible, non-transitory, machine-readable-medium of claim 10, comprising storing the previous search queries performed on the client instance.

15. The tangible, non-transitory, machine-readable-medium of claim 14, comprising generating a score for each previous search query performed on the client instance, and storing the score for each previous search query performed on the client instance.

16. A method for providing search suggestions within a client instance of a cloud computing system, comprising:
receiving a partial search query from a user via a user interface;
determining user search suggestions based on previous search queries performed by the user and the partial search query;
determining instance search suggestions based on previous search queries performed on the client instance and the partial search query;
filtering the instance search suggestions based on one or more instance filter criteria;
ranking the user search suggestions and the instance search suggestions based on one or more ranking criteria; and
enabling selection of the user search suggestions and the instance search suggestions.

17. The method of claim 16, comprising determining whether the user search suggestions and the instance search suggestions comprises a blacklisted term, and removing the user search suggestions and the instance search suggestions that comprise the blacklisted term.

18. The method of claim 16, comprising displaying a first indication of the user search suggestions and a second indication of the instance search suggestions.

19. The method of claim 16, wherein the user interface comprises a web portal, wherein the one or more instance filter criteria comprises search queries performed on the web portal.

20. The method of claim 16, wherein the user interface comprises a mobile interface, wherein the one or more instance filter criteria comprises search queries performed on the mobile interface.
